(19) United States
(12) Patent Application Publication
(10) Pub. No.: US 2012/0082525 A1
(43) Pub. Date: Apr. 5, 2012

(54) SCRAPER SHARPENER

(76) Inventor: Robert Daniel Harris, II, Ashland, OH (US)

(21) Appl. No.: 13/246,925

(22) Filed: Sep. 28, 2011

Related U.S. Application Data
(60) Provisional application No. 61/389,098, filed on Oct. 1, 2010.

(51) Int. Cl. B23C 3/12; B23C 1/20

(52) U.S. Cl. 409/132; 409/138

(57) ABSTRACT

A lightweight, portable motorized scraper sharpener is provided. A housing is formed from a recycled plastic or any other lightweight material, and receives a motor, an on/off switch, and a cutter. The motor and the cutter are encased in the housing. The housing has an angled guideway or slot for insertion of the scraper to be sharpened in the housing, and may include a biasing member for urging the scraper against a support wall. The housing has a cavity for selectively removing the scraper shavings. The assembly can be used in the shop, home, around a ski hill with a portable battery pack, or could alternately be plugged into a car adapter/cigarette lighter.

### BACKGROUND

This application claims priority from U.S. provisional application Ser. No. 61/389,098, filed Oct. 1, 2010, the disclosure of which is expressly incorporated herein in its entirety.

This disclosure is directed to a sharpener assembly, and more particularly to a lightweight, powered sharpener assembly that finds particular application as a tool for sharpening a plastic (Lucite™) scraper used in association with removing wax from snow skis/snowboards. It will be appreciated, however, that the powered sharpener assembly may find application in association with other end uses encountering similar materials that require formation of a new edge.

There is a widespread use of snow skis/snowboards for recreation, exercise, sport, and professional use. For example, Alpine skiing is a popular sport and recreation that includes downhill and slalom skiing. Likewise, cross country skiing has seen a dramatic increase in terms of recreation, and more importantly as a form of low impact exercise. Snowboards have seen an explosive growth in terms of both recreation and sport.

Winter conditions, and likewise snow conditions, can vary widely from one region to another, and also with respect to the day-to-day weather conditions. The temperature and moisture content can result in wide-ranging conditions from powder to ice, and likewise conditions therebetween. Avid skiers recognize that application of different waxes to address different conditions can result in vastly different performance of the snow skis (or snowboards). As will be appreciated, because different waxes have a different impact under different snow conditions, it becomes necessary to remove wax from the ski/snowboard before a new, different wax is applied. The most common manner of removing the wax is to physically scrape the wax from the surface of the ski/snowboard. Moreover, a widely used scraper is a relatively thin plastic scraper, Lucite™ being one commonly used type of a plastic scraper. For example, a scraper may have a generally rectangular form on the order of approximately 3″×6″×0.25″.

Typically, the longer edges of the rectangular scraper are used for removing the wax from the ski/snowboard surface. It is important to maintain a sharp edge (e.g. a 90° edge) so that minimal pressure is required to effectively and efficiently remove the wax from the ski/snowboard.

The edge or edges of the scraper become worn from repeated use, and obviously are most effective when maintained sharp. That is, a sharp edge is one that is 90° from the sides of the rectangular scraper, although it will be appreciated that in still other instances a different angle may be desired for a particular end use. The use of a plastic scraper is desired since the plastic material effectively removes the wax from the ski/snowboard surface without damaging the underlying surface of the ski/snowboard. On the other hand, the plastic material has a tendency to wear rather quickly and thus there is a continuous need to quickly and effectively sharpen the scraper.

Surprisingly, one common manner of sharpening the plastic scraper in the ski/snowboard industry is to secure a file to a work surface. The edge of the plastic scraper is oriented substantially perpendicular to the surface of the file and the scraper manually moved back and forth over the file to remove the worn edge of the sharpener, and form a new, sharper edge to the scraper. Still another manner of sharpening the plastic scraper is to use a hand-held, manual carbide. The lack of sophistication is widespread in the ski/snowboard industry. Moreover, this does not solve the problem where a sharpened edge is required quickly and effortlessly when traveling or in the shop.

Thus, a need exists for an alternative method and manner of sharpening a scraper, and particularly a plastic scraper as is commonly used in association with removing wax from skis/snowboards. Moreover, such a solution must be relatively compact, lightweight, effective, inexpensive, and simple to use in order to provide a product that meets industry needs.

### SUMMARY OF THE DISCLOSURE

The subject disclosure provides a lightweight, portable, scraper sharpener assembly that provides support for the scraper as the scraper is advanced through the scraper sharpener assembly.

The scraper sharpener assembly includes a housing that receives a motor for rotating a sharpening tool or cutter relative to the house. A channel or slot is formed in the housing and the slot is dimensioned to receive an associated scraper for selective manual advancement through the slot. The slot has a lower support surface that includes an opening through which the cutter protrudes. Extending generally perpendicular to the lower support surface are first and second spaced support walls that guide and support opposite faces of the associated scraper as the scraper is advanced through the scraper sharpener assembly.

The motor of the scraper sharpener assembly may be alternately powered by an associated AC source, an associated DC source, or a self-contained DC power supply.

A method of sharpening a scraper, and particularly a plastic scraper used for removing wax from skis, includes providing a housing that has a motor, driving a sharpener or cutting tool relative to a support surface, and advancing the scraper along the support surface so that the rotating cutting tool removes a worn surface of the scraper. The support surface is configured to receive the scraper so that the scraper is aligned by support walls extending upwardly from the support surface.

The method includes powering the motor from one of an associated AC source, and associated DC source, or providing a self-contained DC power supply.

A primary advantage is the ability to quickly, easily, and effectively sharpen a worn edge of a scraper.

Another benefit resides in the lightweight, portable nature of the scraper sharpener assembly.

Still another advantage is to provide a diagonal support surface through the housing in order to minimize the size of the housing while providing an elongated support surface that stably positions the scraper as the scraper is advanced through the scraper sharpener assembly.

Still other benefits and advantages of the present disclosure will become apparent upon reading and understanding the following detailed description.

### BRIEF DESCRIPTION OF THE DRAWINGS

FIG. 1 is an isometric view of the scraper sharpener assembly.

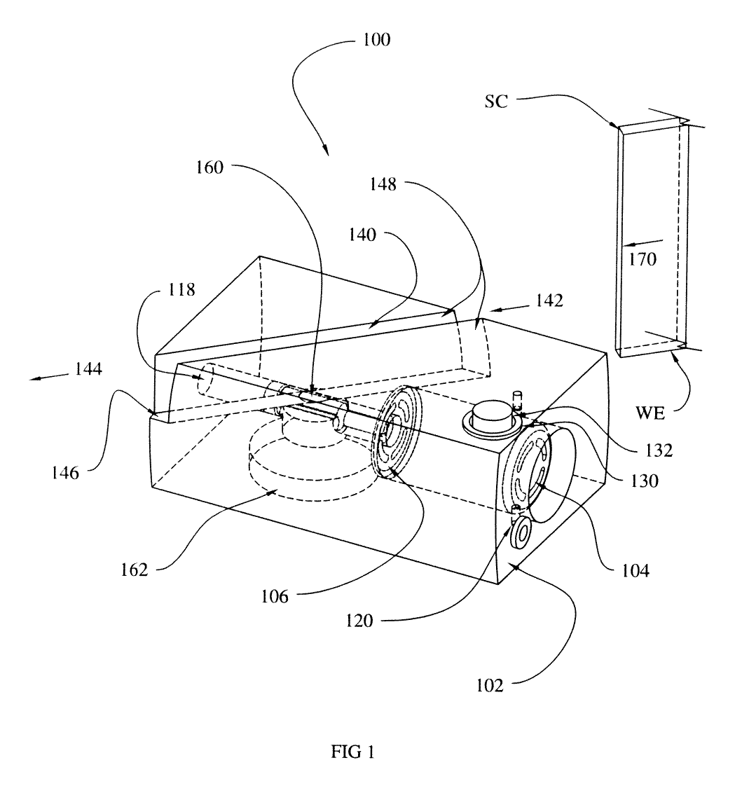

FIG. 2 is another isometric view of the scraper sharpener assembly.

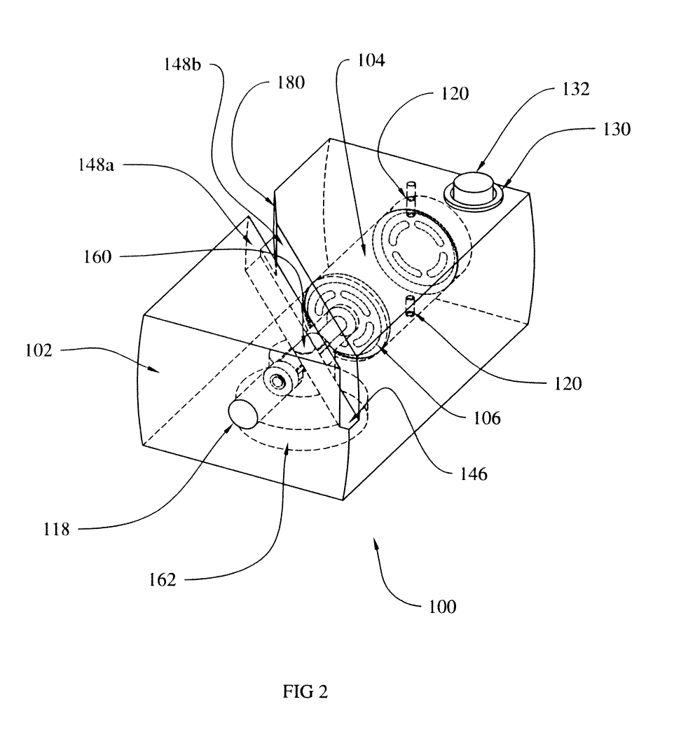

FIG. 3 is a plan view of the assembly.

FIG. 4 is an enlarged elevational view of a preferred cutter.

FIG. 5 is a plan view of a biasing member.

FIG. 6 is an elevational view of the biasing member of FIG. 5.

FIG. 7 is an isometric view of an adjustable support wall.

### DETAILED DESCRIPTION OF THE PREFERRED EMBODIMENTS

A scraper sharpener assembly 100 includes a housing 102 that is dimensioned to be lightweight and portable, e.g., approximately 4′×6″ by 2″, although these dimensions are exemplary only. The housing 102 includes a drive motor 104 that is powered by an associated AC source, an associated DC source, or alternatively by a DC source incorporated into the housing. Thus, the scraper sharpener assembly 100 may be plugged into an associated wall socket to be operative via the AC source, or may include a converter that plugs into the wall source and provides a DC current to the motor, or may include a self-contained battery pack or rechargeable battery pack that provides the desired DC power to the motor.

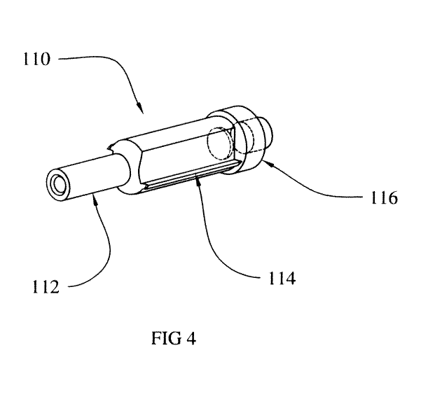

Extending from an inner end 106 of the motor 104 is a rotary cutter member 110 (FIG. 4). The cutter 110 is preferably a rotary cutting tool such as a conventional router bit assembly that includes a drive shaft portion 112 at one end which is releasably mounted to the drive motor, one or more peripheral cutting blades 114, and a guide or bearing portion 116 adjacent a second end that is received in a support surface 118 of the housing 102. The motor 104 is securely mounted in the housing against rotation or axial movement, for example by one or more fasteners or pins 120 that abut along the motor and maintain the motor in a fixed relation in the housing.

A switch 130 is preferably mounted adjacent the motor 104 and includes a switch member 132 that is selectively actuated to turn the motor on and off. Of course the switch 130 can be integrated into the motor and is preferably accessible from an external surface of the housing 102, or along a power cord to provide for convenient actuation/deactuation of the switch member 132.

A channel or slot 140 extends at an angle across the upper surface of the housing. The slot 140 has a width dimensioned to accommodate a wide variety of thicknesses of the associated plastic scraper SC, although the depth of the slot is not intended to fully receive the scraper therein, but rather only a lower portion thereof. The slot 140 is preferably angled across the housing in order to provide an extended length that provides desired guidance and support of the scraper SC as the scraper is advanced through an inlet 142 and proceeds toward outlet 144 of the slot. More particularly, a lower support surface 146 extends generally perpendicular to first and second support walls 148a, 148b that are generally equally spaced along the length of the slot.

An opening 160 is provided in the support surface 146. Preferably the opening 160 is located toward a middle region of the housing 102, and is more particularly aligned with the cutter that extends from the motor. Perimeter edges of the individual blades 114 of the cutter extend above the support surface 146 so that as the worn edge WE of the scraper SC is advanced through the slot, a predetermined amount of the worn edge from the lower surface of the scraper is removed by the cutter. The opening 160 communicates with a cavity 162 so that removed portions or chips/filings/shavings of the worn edge WE of the scraper SC pass into the cavity 162 and an open mesh screen covers access to the cavity (the screen serving as a finger guard) and yet allows the chips to exit from the housing. It is also contemplated that the cavity may be selectively connected to a vacuum source (not shown) to draw the removed material from the housing, and more specifically from the cavity. For example, the chips/filings/shavings may be collected in a container remotely located and connected to the cavity so that the container can be emptied when desired.

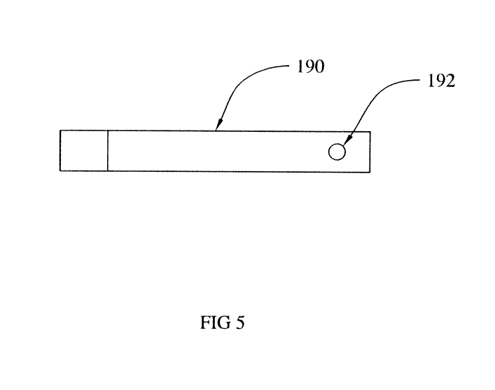

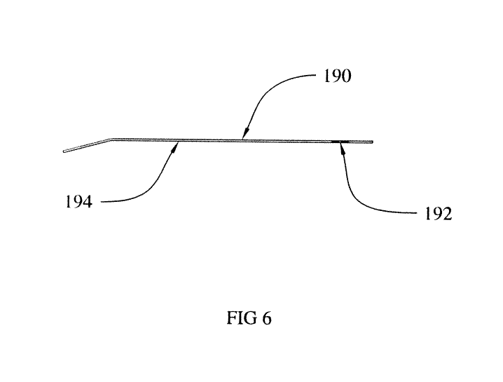

The scraper SC is advanced relative to the housing into the inlet 142 and directed toward the outlet 144 as illustrated by arrow 170. Preferably a chamfer 180 is located along the inlet to facilitate guiding receipt of the leading edge of the scraper SC into the slot. As further illustrated in FIGS. 5 and 6, a biasing member 190 is shown as an elongated strip that is fastened through opening 192 at one end within the slot while the angled edge 194 (FIG. 6) is adapted for engagement with the leading edge of the scraper SC. Preferably the angled edge 194 has the same general contour as the chamfer 180 so that the biasing member 190 urges the scraper SC toward the first support wall 148a.

The slot 140 preferably has a width defined between the support walls 148a, 148b that minimizes the potential for a user to insert their fingers therein. Further, a height of the support walls is preferably sized to receive approximately one-third the height of the plastic scraper SC, although this height may change depending on the size of the scraper.

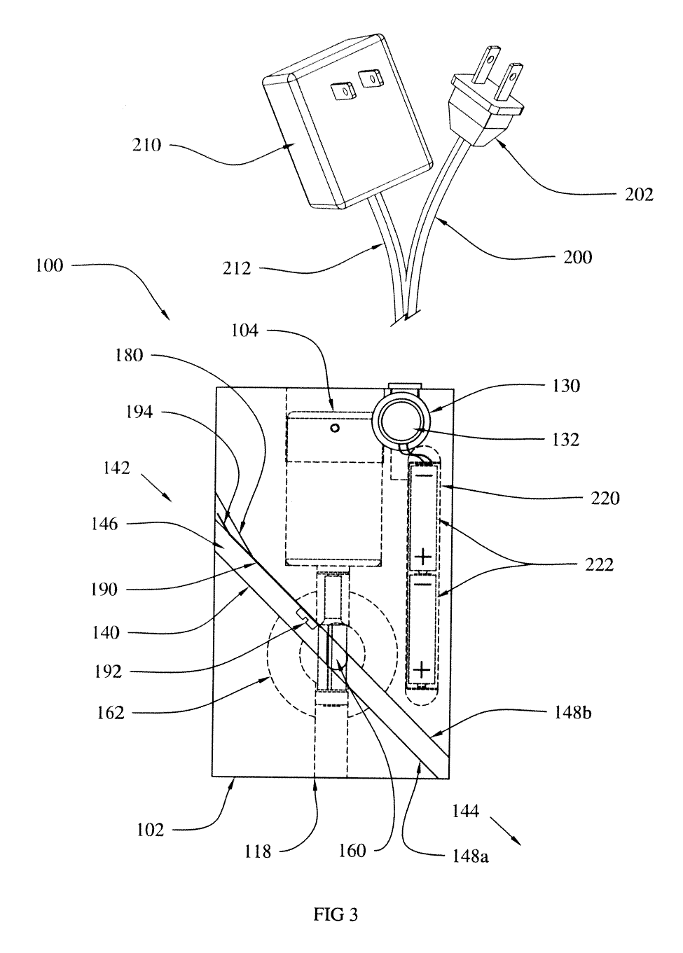

As illustrated in FIG. 3, a power cord 200 may be one means of powering the motor 104. As is conventional, a plug 202 provided at one end of the cord is received in an associated wall socket (not shown) to provide desired AC power to the motor 104. Alternatively, an AC/DC converter 210 plugs into the associated wall socket and provides DC power through cord 212 to the motor. Yet another option is to provide a battery pack 220 that includes one or more batteries 222, which batteries may be rechargeable if desired through use of the AC or DC lines 200, 212. Power to the motor 104 is selectively controlled by the switch 130 no matter which of the power sources is used. Of course, appropriate connections between the motor, switch, and power source are made as will be readily understood by one skilled in the art.

A lightweight (e.g. under 1-¾ pounds, or approximately 2-½ half pounds with the power source) portable motorized scraper sharpener is provided. The housing can be formed from a recycled plastic or any other lightweight material, and receives a motor or powering device, an on/off switch, and a cutter. The motor and the cutter mechanism are encased in the housing. The housing has a guideway or slot for insertion of the scraper to be sharpened in the housing. The housing has a cavity for selectively removing the scraper shavings. The assembly can be used in the shop, home, around a ski hill with a portable battery pack such as a 12 to 28 volt battery pack, or could alternately be plugged into a car adapter/cigarette lighter. One skilled in the art will understand that the assembly can be modified to accommodate any desired voltage or electrical connection so that the scraper sharpener assembly can be used in different locations, different countries, and with different power sources.

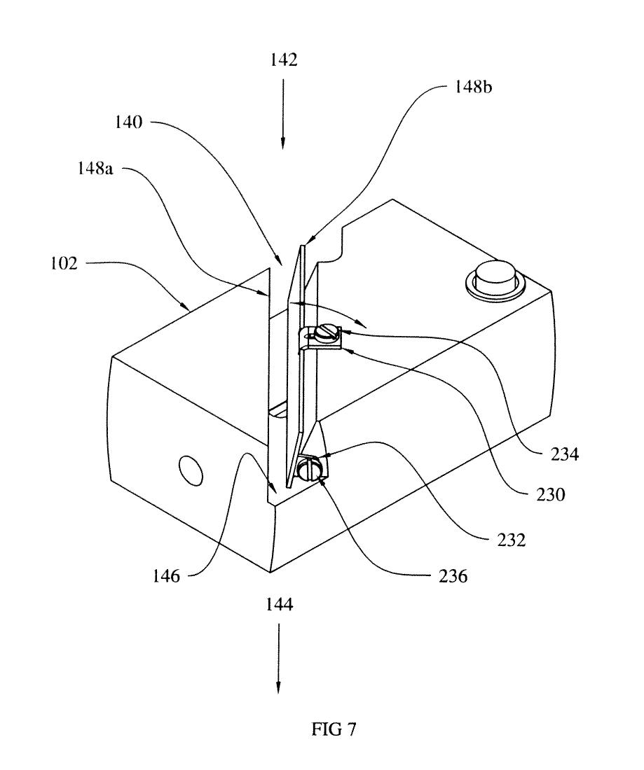

Preferably, the cutter is a carbide material for durability and cutting ability when used with plastic or non-metallic material as is conventional with the scraper. Typically, the angled cut is 90°, although it is understood that the angle may be changed and fixed at another preset angle if so desired. As shown in FIG. 7, the angle at which the scraper engages the cutter may be changed by altering the angle of the support wall 148b, for example. Specifically, one embodiment for altering the angle of the material removed from the worn edge WE of the scraper SC provides a pivoting support wall 148b. First and second pivot points 230, 232 receive set screws 234, 236, respectively, which screws are tightened when the support wall is oriented at the desired angle. Of course, a greater or lesser number of pivot points can be used without departing from the scope and intent of the present disclosure. Once adjusted, the set screws hold the support wall in place, i.e. at the desired angle, so that the scraper SC when supported thereby is disposed at a desired angle relative to the cutter.

A guide system or biasing cutter, i.e., is preferably located in the sharpening slot to assist in keeping the scraper square (or at the desired angle) to the cutter, i.e., preferably biased against one of the support walls. The assembly produces a razor-sharp edge to the previously worn edge of the scraper. The removed cutting chips or filings exit through the bottom of the housing through the screen or into a vented cavity. A lower surface of the housing may include feet to provide increased stability and also to aid in dispersing of the chips, filings or shavings removed by the cutter along the bottom of the housing.

Still another modification relates to changing the depth of the cut or the amount of material that is removed from the worn edge WE of the scraper SC. In this regard, the cutter is typically positioned at a fixed height relative to the opening in the support surface 146. Therefore, to adjust the depth of the cut, a strip(s) or insert(s) may be added to the support surface so that the cutter extends above the strip or insert a smaller dimension than above the support surface 146 and therefore less material is removed from the worn edge of the scraper as the scraper is advanced along the insert at a predetermined height above the upper surface of the support surface 146.

The disclosure has been described with reference to the preferred embodiments. Obviously, modifications and alterations will occur to others upon reading and understanding the preceding detailed description. It is intended that the present disclosure be construed as including all such modifications and alterations in so far as they fall within the scope of the appended claims.

I claim:

1. A scraper sharpener assembly comprising:
a housing;
a motor received in the housing;
a cutter rotated by the motor; and
a slot formed in the housing, the slot has a lower support surface that includes an opening through which the cutter protrudes, spaced first and second support walls extending from the lower support that guide and support opposite faces of the associated scraper as the associated scraper is advanced therethrough.

2. The scraper sharpener assembly of claim 1 wherein the slot is angled across the housing.

3. The scraper sharpener assembly of claim 1 further comprising a biasing member for urgin the associated scraper against the first support wall.

4. The scraper sharpener assembly of claim 1 further comprising a guideway provided at an inlet of the slot for orienting the associated scraper relative to the cutter.

5. A method of sharpening a plastic scraper comprising:
providing a housing having a support surface that receives the plastic scraper;
driving a cutting tool relative to the support surface; and
advancing the scraper along the support surface so that the cutting tool removes a worn surface of the scraper.

6. The method of claim 5 further comprising providing support walls extending upwardly from the support surface.

7. The method of claim 5 further comprising providing a motor for driving the cutting tool.

8. The method of claim 7 further comprising powering the motor by one of an AC source or a DC source.

9. The method of claim 8 wherein the DC source includes a battery pack received in the housing.

10. The method of claim 5 further comprising orienting the support surface at an angle across the housing.
